(19) United States
(12) Patent Application Publication
(10) Pub. No.: US 2023/0363326 A1
(43) Pub. Date: Nov. 16, 2023

(54) HORTICULTURAL MODULE, ASSOCIATED GULLY ASSEMBLY, AND MOVING GULLY SYSTEM FORMED THEREFROM

(71) Applicant: GAIA PROJECT AUSTRALIA PTY LTD, Brunswick, Victoria (AU)

(72) Inventor: Nadun HENNAYAKA, Brunswick, Victoria (AU)

(21) Appl. No.: 18/245,278

(22) PCT Filed: Aug. 25, 2021
(86) PCT No.: PCT/AU2021/050960

§ 371 Date: Mar. 14, 2023

(30) Foreign Application Priority Data
Sep. 16, 2020 (AU) 2020903306

(51) Int. Cl. A01G 9/04; A01G 31/04; A01G 31/06

(52) U.S. Cl. CPC A01G 9/047; A01G 31/04; A01G 31/06

(57) ABSTRACT

A gully assembly configured for use with like gully assemblies to form part of a horticultural moving gully system, the assembly comprising: (a) an elongate crop holder having spaced apart openings for receiving respective crops to be grown and harvested; and (b) a channel in which water can flow over roots of the spaced apart crops; wherein the assembly is configured to enable adjustment of a distance between the spaced apart openings such that crop density can be varied during a crop growing process.

The entire content of the patent specification of Australian provisional patent application number 2020903306 is incorporated herein by reference.

### FIELD OF THE INVENTION

The present patent specification discloses a gully assembly configured to form part of a moving gully system for use in horticultural applications. Also disclosed herein is a horticultural module. The module may be adapted for use with the present gully assembly. The module may be configured to be used in deep water culture hydroponic planting applications.

### BACKGROUND

In various horticulture systems, including hydroponic systems which often utilise the nutrient film technique of crop growing, moving gully systems are used to improve the efficiency and productivity of crop growing by varying the growing area based on plant density.

FIG. 1 shows a schematic of how existing moving gully systems 2 work. Each gully 4 comprises an elongate channel in which crops 6 are planted and grown. The moving gully system 2 is configured such that, as the crops grow, the gullies 4 are progressively spaced apart from one another in a transverse direction. As such, in the earlier stages of the growing process when crops 6 are smaller, crops can be more densely packed together since they would not obstruct one or more crops 6 in an adjacent gully from receiving sunlight and other nutrients. Moving gully systems 2 thus enable crops (such as lettuce) in adjacent gullies 4 to be adequately but not unnecessarily spaced from one another as they grow, thereby more efficiently utilising the limited space in which the crops 6 are grown.

However, existing gullies 4 are themselves unable to adjust a spacing between adjacent crops 6 as they grow. As such, crops 6 grown along a common gully 4 can be spaced apart more than they need to be, particularly when the crops 6 are relatively small during the earlier stages of the growing process. This can result in a less than optimum usage of limited crop growing space, and increased energy consumption.

Moreover, existing gullies 4 are typically relatively long and difficult to transport, clean, adapt for different growing areas, upgrade, set up and/or install. Additionally, if a gully 4 is damaged or malfunctions, it is not unusual for the entire gully 4 to be replaced, and this can be a costly and wasteful expense.

There is a need to address the above, and/or at least provide a useful alternative.

### SUMMARY

According to a first aspect of the present invention, there is provided a gully assembly configured for use with like gully assemblies to form part of a horticultural moving gully system, the assembly comprising:
(a) an elongate crop holder having spaced apart openings for receiving respective crops to be grown and harvested; and
(b) a channel in which water can flow over roots of the spaced apart crops;
wherein the assembly is configured to enable adjustment of a distance between the spaced apart openings such that crop density can be varied during a crop growing process.

In embodiments of the invention, the elongate crop holder comprises a plurality of modules, each module having a respective one of the spaced apart openings and being configured to movably engage at least one adjacent module such that, in use, adjacent modules can move relative to one another so as to increase a distance between spaced apart crops as the crops grow.

In embodiments of the invention, adjacent modules are slidably movable relative to one another.

In embodiments of the invention, adjacent modules are telescopically associated with one another to enable relative movement therebetween.

In embodiments of the invention, each module comprises a tray having a head portion and a tail portion, the head portion of one module being releasably engageable with the tail portion of an adjacent module.

In embodiments of the invention, the modules are releasably securable to the channel so as to substantially close a top of the channel.

In embodiments of the invention, the modules comprise complementary interlocking features for releasably locking adjacent modules together and limiting movement therebetween.

In embodiments of the invention, the channel is configured to extend as the distance between spaced apart openings of the modules increases.

In embodiments of the invention, the channel comprises two or more channel portions connected together, each portion being configured for movable engagement with an adjacent portion such that, in use, adjacent portions can move relative to one another so as to increase a length of the channel defined by the portions as the crops grow.

In embodiments of the invention, the portions are telescopically associated with one another to enable relative movement therebetween.

According to a second aspect of the invention, there is provided a module for use as one of the plurality of modules of an assembly according a first aspect of the invention.

According to a third aspect of the present invention, there is provided a moving gully system for use in horticultural applications comprising two or more adjacent gully assemblies according a first aspect of the invention, the gully system being configured to vary a spacing between crops during the crop growing process by:
(a) increasing a space between adjacent gullies as the crops grow; and
(b) increasing a distance between adjacent crops as the crops grow.

### BRIEF DESCRIPTION OF THE DRAWINGS

In order that the invention may be more easily understood, an embodiment will now be described, by way of example only, with reference to the accompanying drawings in which:

FIG. 1 is a top schematic view of a prior art moving gully system;

FIG. 2 is a top perspective view of a moving gully system formed from gully assemblies according to embodiments of the present invention;

FIG. 3 is a top view of a moving gully system formed from gully assemblies according to embodiments of the present invention;

FIG. 4(a) is a rear perspective view of an outer channel portion of a gully assembly according to embodiments of the present invention;

FIG. 4(b) is a front perspective view of an inner channel portion of a gully assembly according to embodiments of the present invention;

FIG. 5(a) is a front perspective view of the outer channel portion of FIG. 4(a);

FIG. 5(b) is a rear perspective view of the inner channel portion of FIG. 4(b);

FIG. 6(a) is a rear cross-sectional view of the inner channel portion of FIG. 5(b);

FIG. 6(b) is a rear cross sectional view of the outer channel portion of FIG. 5(a);

FIGS. 7(a) and 7(b) are, respectively, front and rear perspective views of a module according to embodiments of the present invention, for use with a gully assembly according to embodiments of the present invention;

FIGS. 8(a) and 8(b) are, respectively, front and rear views of the module of FIG. 7(a);

FIG. 9(a) is a front perspective view of the module of FIG. 7(a), fitted with a pot for holding a crop, which pot can be twistably locked to the module;

FIG. 9(b) is a bottom perspective view of the arrangement of FIG. 9(a);

FIG. 10(a) is a front cross-sectional view of a gully assembly according to embodiments of the present invention; and

FIG. 10(b) is a rear cross-sectional view of the gully assembly of FIG. 10(a).

### DETAILED DESCRIPTION

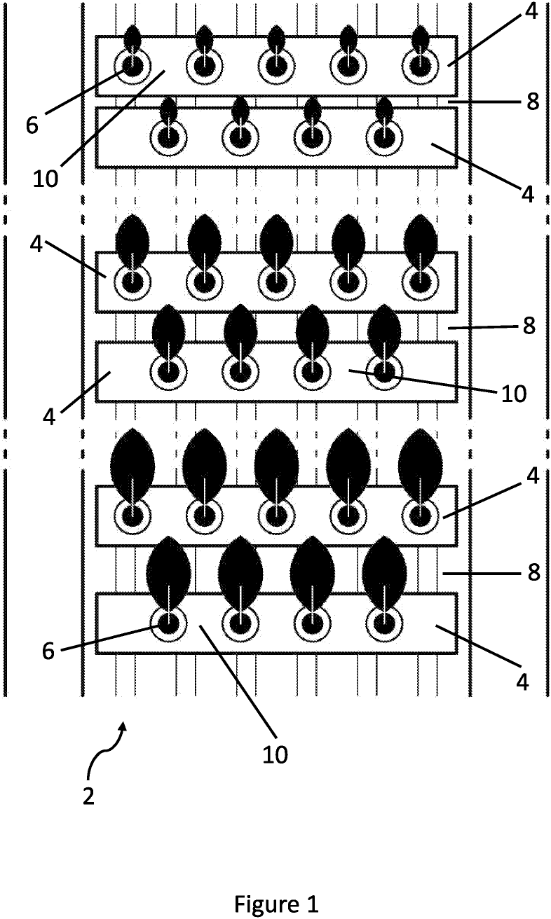

FIG. 1 shows a prior art moving gully system 2 whose gullies 4 progressively travel from a planting end (i.e., top of FIG. 1) to a harvesting end (i.e., bottom of FIG. 1). As the gullies 4 travel across the growing field, a space 8 between adjacent gullies 4 is configured to widen as the crops 6 grow.

However, with existing gullies 4, the spacing 10 between adjacent crops 6 planted along the same gully 4 is fixed. As such, crops 6 planted along a common gully 4 must be spaced from one another as though they are fully grown and ready to be harvested, even though for the vast majority of the growing process, the crops 6 do not require this much space 10 between them.

For example, the topmost planting end of FIG. 1 shows a relatively early stage of the growing process and yet the crops 6 along the gullies 4 are spaced from one another to a relatively large extent 10 in order to accommodate future crop growth. If the spacing or distance 10 between adjacent crops 6 along a gully 4 could also be varied with the growing process, the limited growing space could be better utilised and lead to increases in productivity and efficiency, including reductions in energy consumed by lighting and environmental control systems which would otherwise be utilised for unused space of the overall moving gully system 2.

Additionally, reducing unnecessary spacing 10 between plants 6 along a gully 4 can decrease the overall space required to grow the crops 6. This can be particularly important in vertical and/or indoor farming systems which use artificial lighting, wherein space and energy savings can be quite significant.

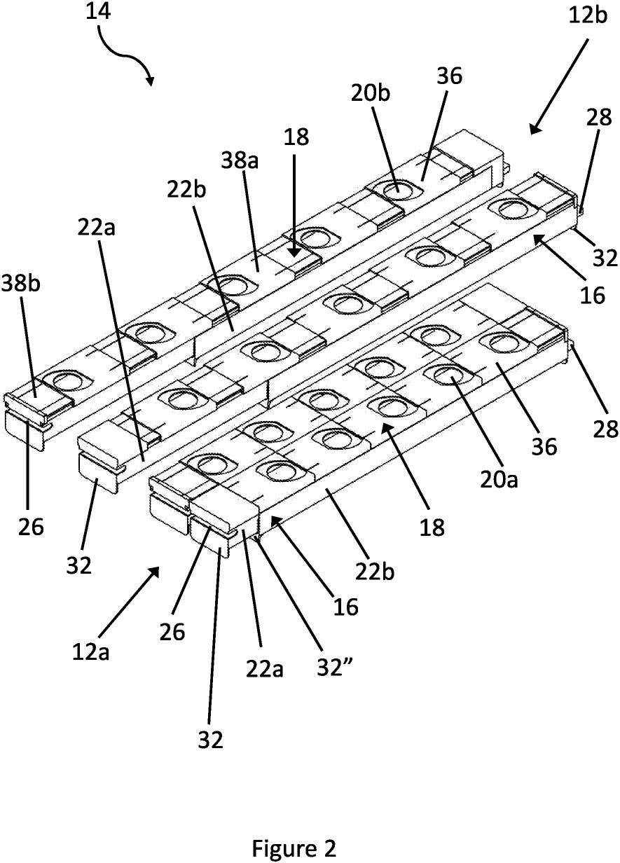

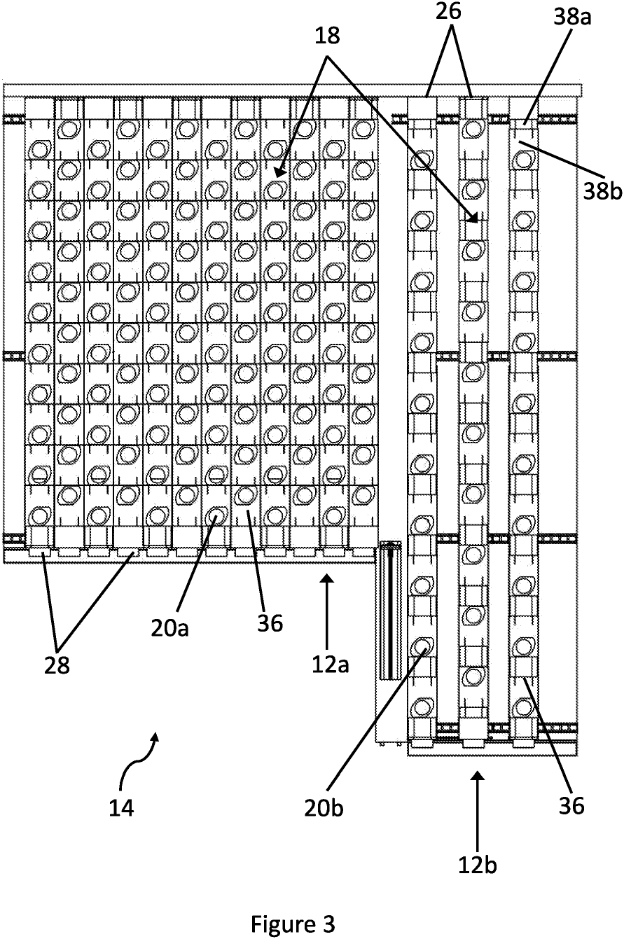

With reference to FIGS. 2 and 3, embodiments of the present invention provide a gully assembly 12 that can form part of a moving gully system 14 that allows for variation of a distance between adjacent crops planted along a common gully 12. As such, spacing between crops can be varied during the growing process not just in the transverse direction (i.e., between adjacent gullies 16), but also in the longitudinal direction (i.e. along the same gully 16).

FIG. 2 shows four gullies 12 according to embodiments of the invention. As will be described, each gully assembly 12 comprises a channel 16 in which water can flow to nourish the crops via the nutrient film technique, and an elongate crop holder 18 having spaced apart openings 20 for receiving respective crops to be grown. The gully 12 is configured such that a spacing or distance between the spaced apart openings 20, and thus the spacing between adjacent crops planted therein, can be increased as the crops grow.

A first pair of gully assemblies 12a is shown in a retracted state wherein openings 20a for receiving crops are relatively close to one another. This arrangement would be suitable for earlier stages of the growing process wherein adjacent gullies 12a can be closer to one another, and crops along a common gully 12a can be closer to one another, thereby allowing more crops to be planted and grown in a given space.

A second pair of assemblies 12b is shown in an extended state. In particular, the extended assemblies 12b are spaced from one another in the transverse direction, and the spacing between adjacent crop holding openings 20b has increased so that the crops, which are now larger, can still be adequately spaced from one another. This extended arrangement of the assemblies 12b would be suitable for later stages in the growing process so that there is adequate spacing between adjacent crops so they do not obstruct one another’s ability to gather sunlight and other nutrients.

FIG. 3 shows a moving gully system 14 wherein each gully 12 is formed from a gully assembly 12 according to embodiments of the present invention. At the early planting end of the crop growing process, adjacent gullies 12a, along with adjacent openings 20a of each gully 12a, are relatively close to one another. As the crops grow and advance along the moving gully system 14 toward a harvesting end, adjacent gullies 12b, along with adjacent openings 20b of each gully 12, are increasingly spaced from one another. In this way, crop density and space utilisation can be better optimised and aligned throughout changing crop growing process.

A gully assembly 12 according to embodiments of the present invention will now be described.

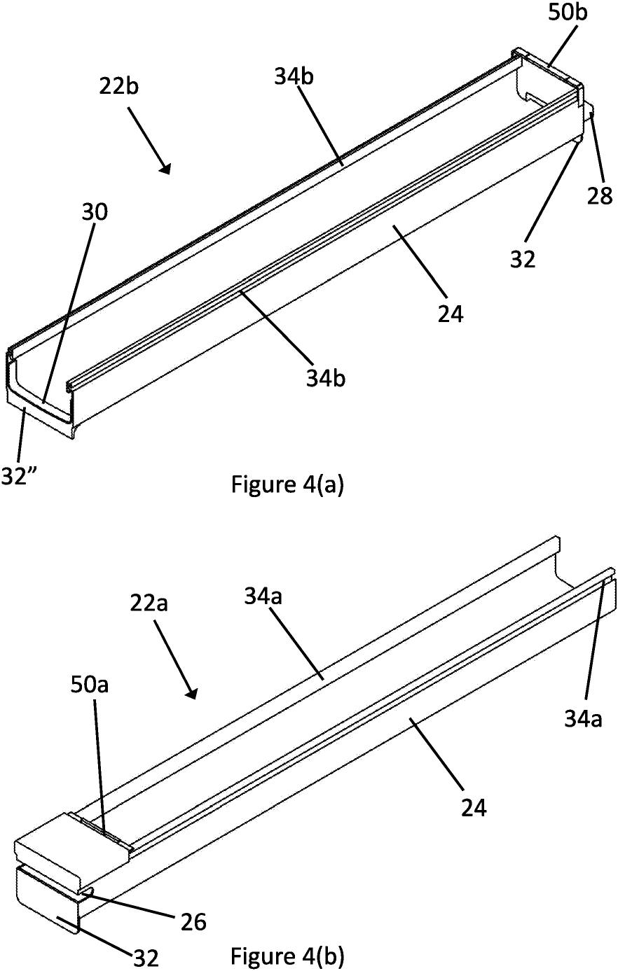

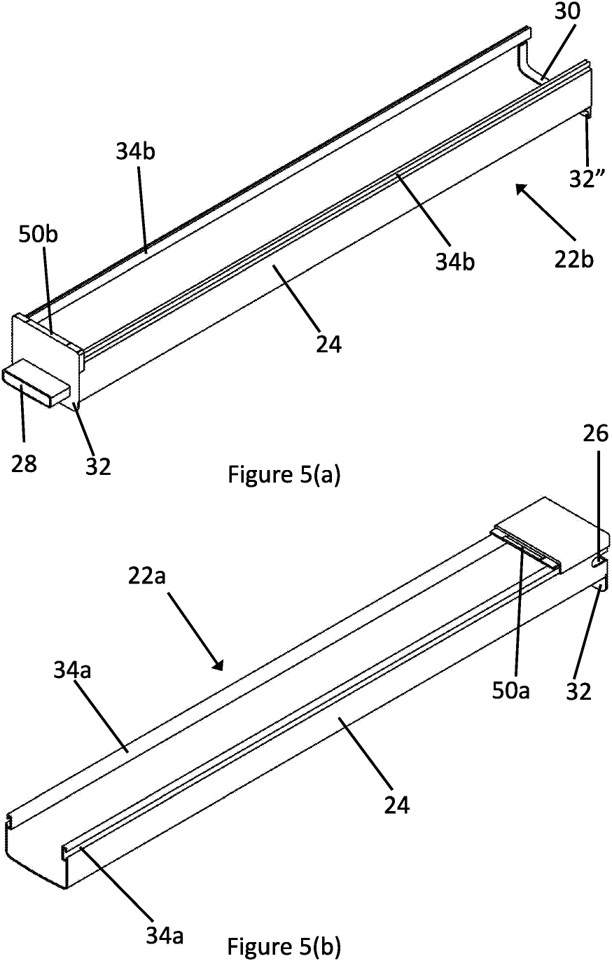

Referring to FIGS. 4(a) to 5(b), the gully assembly 12 comprises two channel portions 22a, 22b having elongate bodys 24 arranged to slidably engage one another to form an extendible channel 16 of the gully assembly 12 in which water can flow to nourish the planted crops. The extendible channel 16 comprises an inner channel portion 22a and an outer channel portion 22b, the inner channel 22a being configured to be at least partially nested or received in the outer channel 22b.

The inner channel 22a comprises a water inlet 26 via which water can enter the channel 16, and the outer channel 22b comprises an outlet 28 via which water can exit the channel 16 after flowing over the roots of the planted crops. The outer channel 22b may comprise sealing means, such as EPDM rubber 30, to seal against leakage from between the connected channel portions 22a, 22b.

Referring to FIG. 2, when the gully assemblies 12a are retracted, the inner channel 22a is substantially contained within the outer channel 22b. The inner channel 22a is extendible out from the outer channel 22b in the longitudinal direction so as to increase the length of the combined channel 16 of the gully 12b. To this end, the channel portions 22a, 22b may comprise features that facilitate the slidable movement of the channel portions 22a, 22b relative to one another. For example, in the depicted embodiment, the channel portions 22a, 22b comprise respective downwardly extending lips 32, 32″ that can be driven (e.g., pulled or pushed in the longitudinal direction) via an automated mechanism to move the gully assembly 12 from the retracted state to the extended state.

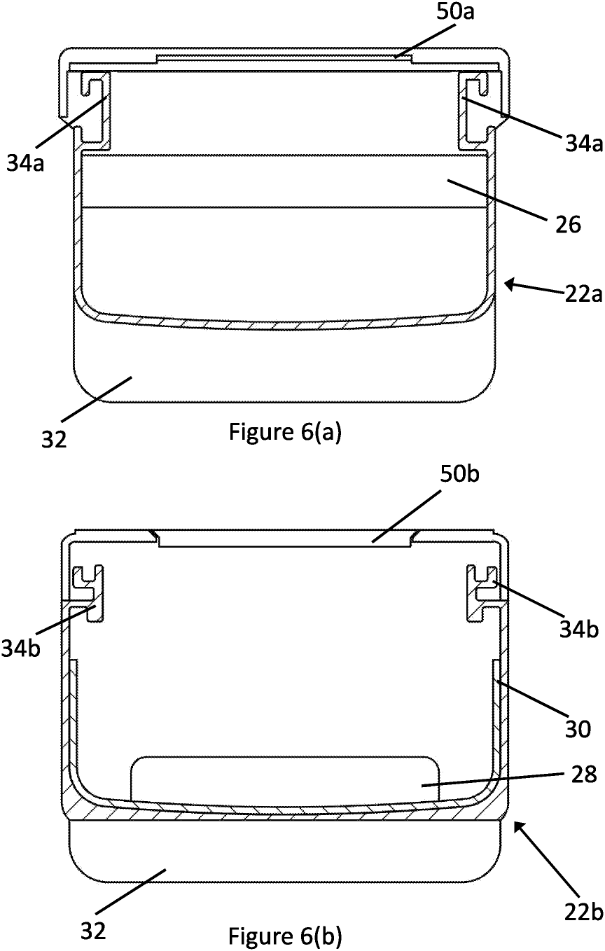

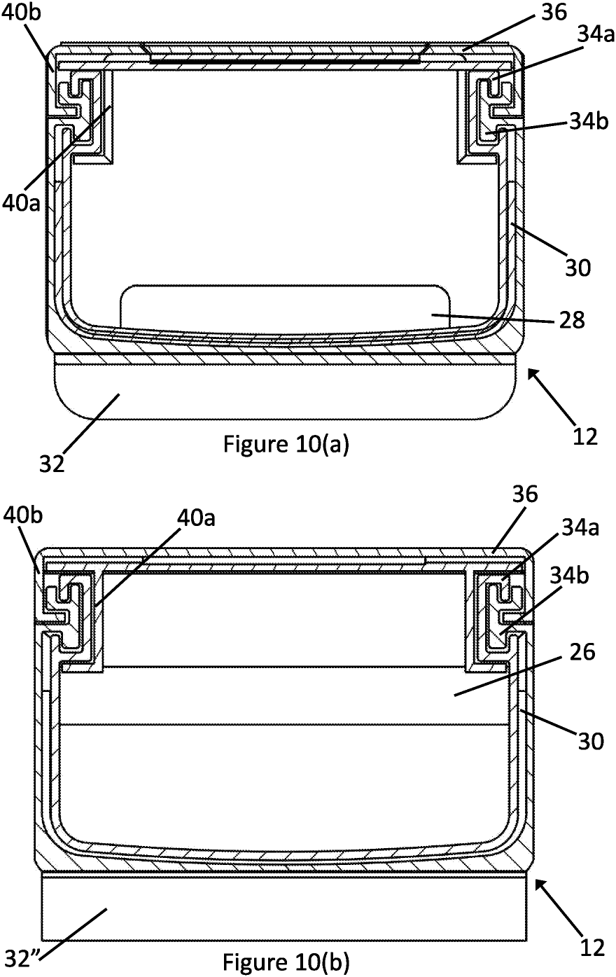

Referring to FIGS. 6(a) and 6(b), the upper end of the longitudinal sides of each channel portion 22a, 22b comprises complementary guides, grooves or railing 34 to enable both channel portions 22a, 22b to be slidably engageable with one another in the longitudinal direction. This engagement is illustrated in FIGS. 10(a) and 10(b), wherein the C-shaped railing 34a of the inner channel 22a substantially receives the railing 34b of the outer channel 22b. This engagement between the two channel portions 22a, 22b helps to lock their positions relative to one another except in the longitudinal direction, thereby ensuring the extendible channel 16 of the gully assembly 12 maintains a relatively straight and elongate form during expansion. To facilitate a watertight lock, when secured together, the channel portions 22a, 22b urge therebetween the rubber seal 30 to maintain a pressure thereon.

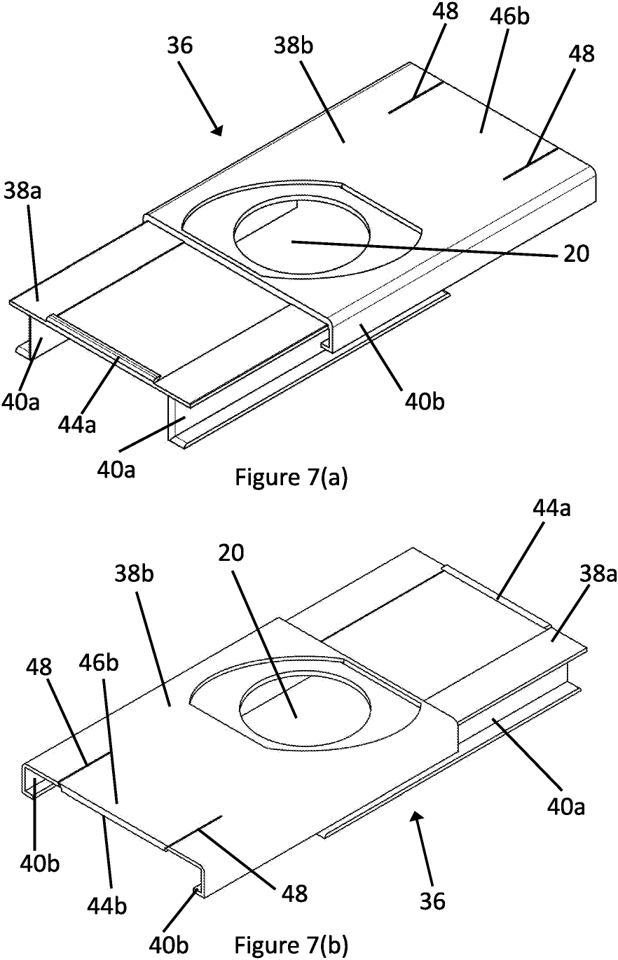

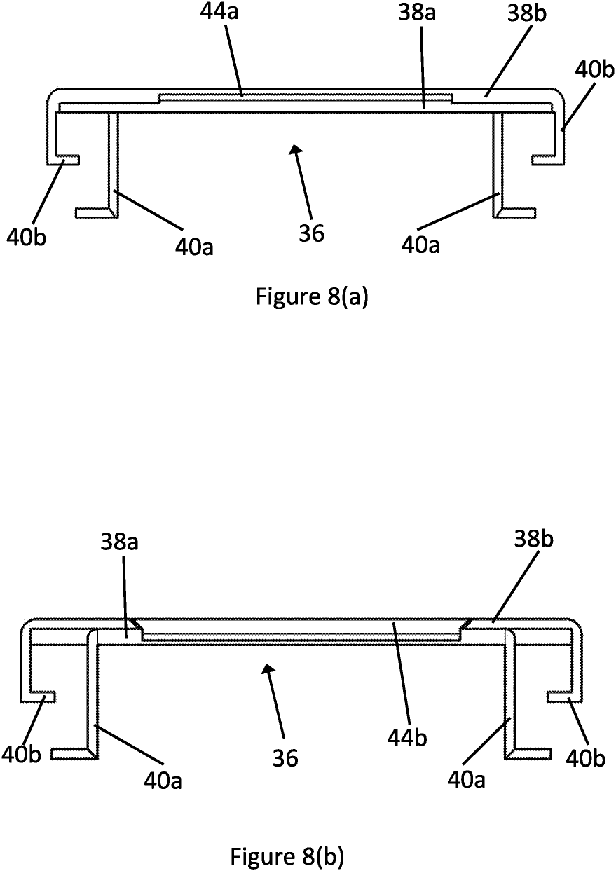

FIGS. 7(a) to 9(b) show a tray-like module 36 having an opening 20 configured for receiving a crop to be grown. The module 36 is configured to be interconnectible to adjacent like modules 36 to form an extendible elongate crop holder 18 of the present gully assembly 12. The module 36 comprises a head element 38a and a tail element 38b, wherein the head 38a of one module 36 is releasably securable to the tail 38b of a like module 36. To this end, and with reference to FIGS. 8(a) and 8(b), each of the head and tail elements 38a, 38b is provided with lateral, longitudinally extending and complementary grooves or rail-like features 40a, 40b via which the head 38a of one module 36 can be slotted at least partially into or beneath the tail 38b of another like module 36.

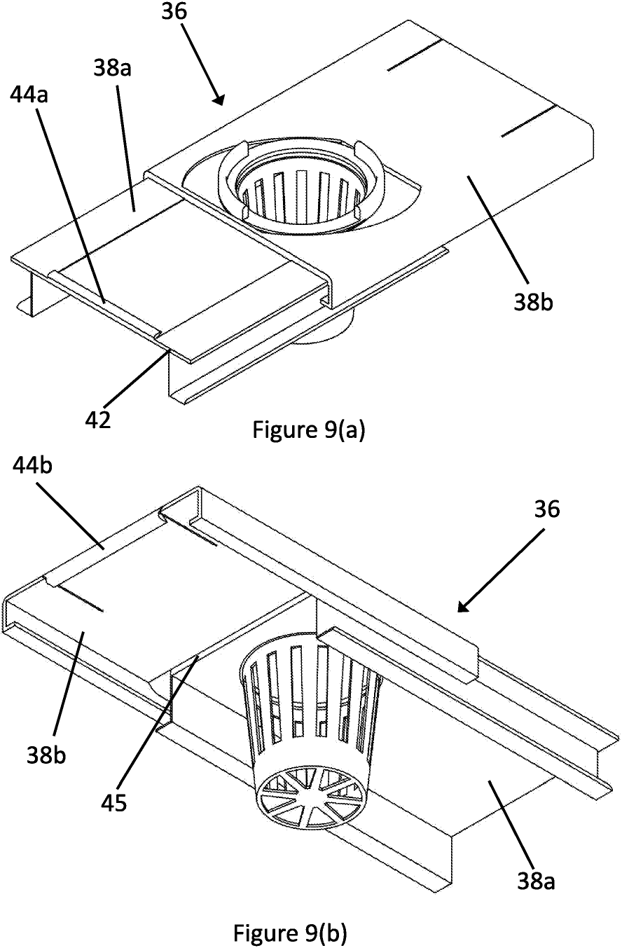

With reference to FIGS. 9(a) and 9(b), when the modules 36 are in the retracted configuration, a front edge or wall 42 of the head element 38a is configured to abut against a front wall 45 of the tail element 38b.

During the crop growing process, adjacent modules 36 can be progressively moved away from one another to increase the distance between their respective crop holding openings 20. In the depicted embodiment, the head element 38a of one module 36 would progressively slide out from beneath the tail element 38b of an adjacent module 36.

The modules 36 are also configured with locking or limiting means 44 which act to limit the maximum extent to which they can slide away from one another. For example, with reference to FIGS. 9(a) and 9(b), the head element 38a is provided with an upwardly projecting lip 44a, and the tail element 38b is provided with a complementary downwardly projecting lip 44b. The modules 36 are configured to slide outwardly relative to one another until the lips 44a, 44b abut one another, which abutment limits further expansion or sliding between the adjacent modules 36.

To facilitate a releasable connection between modules 36, the head and/or tail elements 38a, 38b of each module 36 may be configured with resiliently deformable flap or tab-like features 46. For example, with reference to FIGS. 7(a) and 7(b), the tail 38b is provided with a pair of parallel and spaced apart slots 48, between which is defined a central flap or tab-like feature 46b of the tail 38b that can be resiliently urged upwardly and downwardly. In this way, modules 36 can be clipped to and unclipped from one another via a snap-fit mechanism by prying upwardly on the flap-like feature 46b of the tail 38a and clipping the downwardly projecting lip 44b relative to the upwardly projecting lip 44a of the head 38a.

With reference to FIGS. 10(a) and 10(b), the longitudinal rail-like guides 40a, 40b of the module 36 also enable the module 36 to slidably engage the corresponding railing 34a, 34b of the inner and outer channels 22a, 22b of the gully assembly 12. In the depicted embodiment, the inner L-shaped railing 40a of the head element 38a is configured to slidably receive the C-shaped railing 34a of the inner channel. Meanwhile, the outer L-shaped 40b railing of the tail element 38b is configured to be slidably received by the railing 34b of the outer channel 22b. In this way, when assembled, the position of each module 36 is substantially locked to the elongate channel 16, except for in the longitudinal direction so that the modules 36 can be gradually spaced apart from adjacent modules 36 in the direction of the channel 16.

Referring back to FIGS. 2 and 3, with the modules 36 interconnected with one another and to the channel portions 22a, 22b so as to substantially enclose a top of the combined channel 16, the row of modules 36 together define an elongate crop holder 18 having spaced apart openings 20 for receiving respective crops. Meanwhile, the channel portions 22a, 22b functionally define a single channel 16 in which water can enter via an inlet end 26, flow over the roots of the spaced apart crops, and exit via an outlet end 28.

As each longitudinal gully assembly 12 progresses along a moving gully system 14 formed therefrom, and as the crops grow, the channel portions 22a, 22b can be progressively extended relative to one another so as to extend the overall length of the channel 16. It is envisaged that extension of the channel 16 is configured to cause corresponding slidable movement of the modules 36 so that the openings 20 thereof are increasingly spaced from one another. To this end, with reference to FIGS. 4(a) to 6(b), the inlet end 26 of the inner channel 22a and the outlet end 28 of the outer channel 22b comprise projecting lips 50 arranged to engage the lips 44 of the modules. For example, the downwardly projecting lip 50b of the outer channel 22b is arranged to clip over the upwardly projecting lip 44b of the tail element 38b of the module 36. Similarly, the upwardly projecting lip 50a of the inner channel 22a is arranged to clip under the downwardly projecting lip 44a of the head element 38a of the module 36. In this way, as the channel portions 22a, 22b are slid away from one another, the corresponding inlet and outlet ends of the channel portions 22a, 22b, which are clipped to respective ends of the interconnected modules 36, act to pull in opposite directions on respective ends of the linked of modules 36, thereby drawing adjacent modules 36 away from one another so as to increase a distance between the crop holding openings 20 thereof.

It will be appreciated that the modules 36 are configured such that they are securable and slidable relative to both of the inner and outer channels 22a, 22b. This is particularly relevant for modules 36 which may begin the crop growing process secured to the outer channel 22b, but then slide onto the inner channel 22a as the channel 16 extends (as per FIG. 2). To this end, and with reference to FIGS. 10(a) and 10(b), prior to extension of the gully assembly 12, all modules 36 are slidably engaged with the outer channel 22b. In particular, the outer L-shaped grooves or railing 40b are engaged with or at least partially received by the corresponding longitudinal railing 34b of the outer channel 22b. As the inner channel 22a extends out from the outer channel 22b so as to effect elongation of the overall gully 12, some modules 36 will no longer be directly engaged with the outer channel 22b, but will instead progress so as to slidably engage the inner channel 22a. In particular, these modules 36 smoothly transition to the inner channel 22a whereby the inner L-shaped railing 40a engages or receives the C-shaped railing 34a of the inner channel 22a.

Many modifications of the above embodiments will be apparent to those skilled in the art without departing from the scope of the present invention. For example, the channel 16 could be formed as a single, telescopically extendible channel. Alternatively, the channel 16 may also be formed from more than two channel portions.

It is envisaged that the elongate crop holder 18 (e.g., formed from interconnected modules 36), need not be securable to the channel 16 (e.g., the modules 36 could simply be suspended above or sit on the channel 16. It is also envisaged that the crop holder 18 can be extendible independently from the channel 16.

The elongate crop holder 18 need not be formed from a plurality of individual modules 36 joined together. In alternative embodiments, the crop holder 18 could be formed from telescopically associated modules that are fixed or otherise not readily disconnectible from one another.

In another embodiment, it is envisaged that the channel portions and the modules are not physically distinct from one another. For example, in addition to having a crop holding upper face, each module could also comprise a body that, when joined with the bodies of adjacent modules, defines an elongate channel through which water can flow.

While the foregoing discussion has primarily been in the context of a horizontal moving gully system, embodiments of the present gully assembly, and the novel and inventive aspects thereof, can of course be adapted for other plant growing techniques and situations. For example, the expandable gully assembly may be utilised in vertical farming or planting configurations and installations.

The foregoing discussion and figures primarily relate to a moving gully system having modules that are telescopically linked to one another and secured to a channel in which water can flow. However, the modular nature and extendible functionality of the modules 36 need not be confined to a moving gully system, nor an elongate channel. For example, it is envisaged that the interconnectible modules can be used in other plant growing conditions, such as deep water culture (also known as deep flow technique or floating raft technology), wherein the modules could simply be arranged to float on a body of water. In such embodiments, the modules need not comprise grooves or railing that enable attachment to a channel. The modules simply need to be movably interconnectible to adjacent modules (e.g., telescopically) so that they can extend away from one another during the crop growing process. The geometry of the modules and the material they are made from may also be configured to facilitate the stable floating of the modules on the body of water.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

What is claimed is:

1. A gully assembly configured for use with like gully assemblies to form part of a horticultural moving gully system, the assembly comprising:
(a) an elongate crop holder having spaced apart openings for receiving respective crops to be grown and harvested; and
(b) a channel in which water can flow over roots of the spaced apart crops;
wherein the assembly is configured to enable adjustment of a distance between the spaced apart openings such that crop density can be varied during a crop growing process.

2. The assembly of claim 1, wherein the elongate crop holder comprises a plurality of modules, each module having a respective one of the spaced apart openings and being configured to movably engage at least one adjacent module such that, in use, adjacent modules can move relative to one another so as to increase a distance between spaced apart crops as the crops grow.

3. The assembly of claim 2, wherein adjacent modules are slidably movable relative to one another.

4. The assembly of claim 2, wherein adjacent modules are telescopically associated with one another to enable relative movement therebetween.

5. The assembly of claim 2, wherein each module comprises a tray having a head portion and a tail portion, the head portion of one module being releasably engageable with the tail portion of an adjacent module.

6. The assembly of claim 2, wherein the modules are releasably securable to the channel so as to substantially close a top of the channel.

7. The assembly of claim 2, wherein the modules comprise complementary interlocking features for releasably locking adjacent modules together and limiting movement therebetween.

8. The assembly of claim 2, wherein the channel is configured to extend as the distance between spaced apart openings of the modules increases.

9. The assembly of claim 8, wherein the channel comprises two or more channel portions connected together, each portion being configured for movable engagement with an adjacent portion such that, in use, adjacent portions can move relative to one another so as to increase a length of the channel defined by the portions as the crops grow.

10. The assembly of claim 9, wherein the portions are telescopically associated with one another to enable relative movement therebetween.

11. A module for use as one of the plurality of modules of the assembly according claim 2.

12. A moving gully system for use in horticultural applications comprising two or more adjacent gully assemblies according to claim 1, the gully system being configured to vary a spacing between crops during the crop growing process by:
(a) increasing a space between adjacent gullies as the crops grow; and
(b) increasing a distance between adjacent crops as the crops grow.
